(19) United States
(12) Patent Application Publication
(10) Pub. No.: US 2026/0161906 A1
(43) Pub. Date: Jun. 11, 2026

(54) Dynamic Activation of Mobile Phone Frames in an Indicia Reader

(71) Applicant: Zebra Technologies Corporation, Lincolnshire, IL (US)

(72) Inventors: Christopher P. Klicpera, Westbury, NY (US); Nina Feinstein, Hicksville, NY (US)

(21) Appl. No.: 18/971,924

(22) Filed: Dec. 6, 2024

(51) Int. Cl. G06K 7/10

(52) U.S. Cl. CPC G06K 7/1095; G06K 7/10752; G06K 7/10801

(57) ABSTRACT

The present disclosure relates to an indicia reader capable of dynamically switching between modes optimized for reading barcodes on electronic displays and non-electronic media. The reader includes a housing containing an imaging assembly with an image sensor and lens, an illumination assembly, and a Neural Processing Unit (NPU) executing a machine learning model. The NPU processes captured image data to detect the presence of a display device within the field of view. Based on this detection, the indicia reader adjusts its settings to operate in a mode optimized for the detected media type, enhancing barcode reading performance.

### BACKGROUND

Traditional barcode readers struggle to read information presented on a mobile phone (also referred to as a cell phone) or other devices having a screen. This happens because cell phone screens normally employ some type of glass which, when illuminated by the barcode reader's illumination system, causes specular reflection that obscures the data presented on the screen. To address this, barcode readers have modes where so-called cell-phone frames are inserted into the imaging sequence of an imaging session (also referred to as a decode or decoding session) where the reader alternated between capturing cell-phone frames and regular frames. This, however, dramatically reduces the performance of a barcode reader when reading barcodes on printed medium like paper. As a result, there cell-phone frame interleaving modes are commonly left off altogether to maintain reliable performance. Accordingly, there exists a need for system, devices, and methods for enabling a barcode reader to effectively capture barcodes on electronic displays while maintaining high levels of performance of reading barcodes on printed media.

### SUMMARY

In an embodiment, the present invention is an indicia reader comprising: a housing; an imaging assembly housed within the housing, the imaging assembly including an image sensor and an imaging lens assembly configured to focus light onto the image sensor; an illumination assembly configured to illuminate a field of view of the image sensor; a Neural Processing Unit (NPU) configured to execute a machine learning model; a controller operatively connected to the imaging assembly, the illumination assembly, and the NPU, the controller being configured to cause the indicia reader to: capture, via the imaging assembly, image data during a decoding session; process the image data using the NPU to determine a presence of a display device within the field of view; responsive to the presence of the display device within the field of view, maintaining the indicia reader or adjusting the indicia reader to operate in a first mode optimized for reading indicia on an electronic display; and responsive to a lack of the presence of the display device within the field of view, maintaining the indicia reader or adjusting the indicia reader to operate in a second mode optimized for reading indicia on non-electronic-display media.

In another embodiment, the present invention is a method of operating an indicia reader, the method comprising: capturing image data via an imaging assembly during a decoding session, the imaging assembly including an image sensor and an imaging lens assembly configured to focus light onto the image sensor; processing the image data using a NPU executing a machine learning model to determine a presence of a display device within a field of view; responsive to the presence of the display device within the field of view, maintaining or adjusting the indicia reader to operate in a first mode optimized for reading indicia on an electronic display; and responsive to a lack of the presence of the display device within the field of view, maintaining or adjusting the indicia reader to operate in a second mode optimized for reading indicia on non-electronic-display media.

In yet embodiment, the present invention is a non-transitory computer-readable medium storing instructions that, when executed by a processor, cause an indicia reader to perform operations comprising: capturing image data via an imaging assembly during a decoding session, the imaging assembly including an image sensor and an imaging lens assembly configured to focus light onto the image sensor; processing the image data using a NPU executing a machine learning model to detect a presence of a display device within a field of view; responsive to the presence of the display device within the field of view, maintaining or adjusting the indicia reader to operate in a first mode optimized for reading indicia on an electronic display; and responsive to a lack of the presence of the display device within the field of view, maintaining or adjusting the indicia reader to operate in a second mode optimized for reading indicia on non-electronic-display media.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a perspective front and back view of an optical imaging reader in accordance with various embodiments of the present disclosure.

FIG. 2 illustrates a perspective front view of another optical imaging reader in accordance with various embodiments of the present disclosure.

FIG. 3 illustrates a perspective front view of another optical imaging reader in a form of a mobile device in accordance with various embodiments of the present disclosure.

FIG. 4 illustrates a schematic block diagram of various components of an example imaging apparatus in accordance with various embodiments of the present disclosure.

FIG. 5 is an example representation of a flowchart representative of a method of operating an optical imaging reader in accordance with an embodiment of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

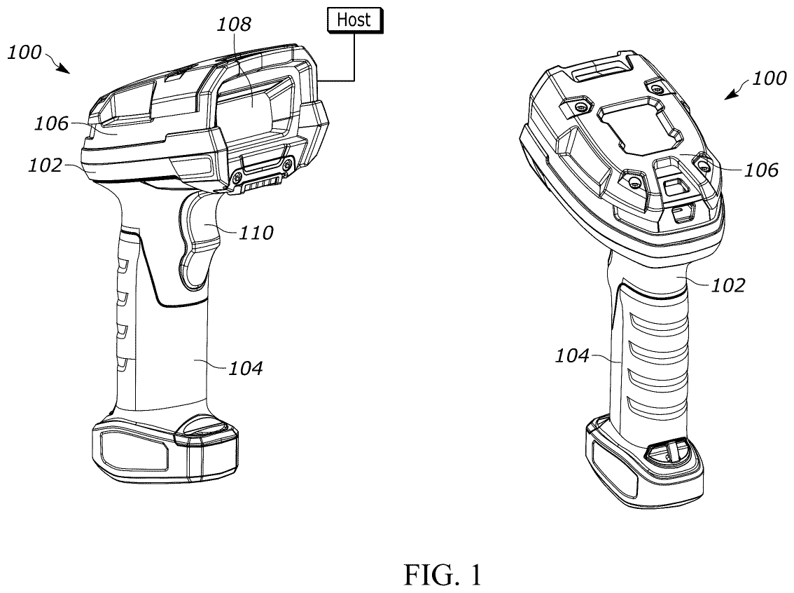

Referring to FIG. 1, shows therein is an exemplary embodiment of an optical imaging reader 100 (also referred to as a barcode reader or indicia reader) and the components thereof. The reader 100 includes a housing 102 with a handle portion 104, also referred to as a handle 104, and a head portion 106, also referred to as a scanning head 106. The head portion 106, which is positioned on the top of the handle portion 104, includes an imaging assembly positioned therein and a window 108. The handle portion 104 is configured to be gripped by an operator (not shown) and includes a trigger 110 for activation by the operator. Optionally included in an embodiment is also a base (not shown), also referred to as a base portion, that may be attached to the handle portion 104 opposite the head portion 106, and be configured to stand on a surface and support the housing 102 in a generally upright position. The barcode reader 100 can be used in a hands-free mode as a stationary workstation when it is placed on a countertop or other workstation surface. The barcode reader 100 can also be used in a handheld mode when it is picked up off the countertop or base station, and held in an operator's hand. In the hands-free mode, items can be slid, swiped past, or presented to the window 108 for the reader to initiate indicia-reading operations. In the handheld mode, the barcode reader 100 can be moved towards a barcode on a product, and the trigger 110 can be manually depressed to initiate imaging of the barcode.

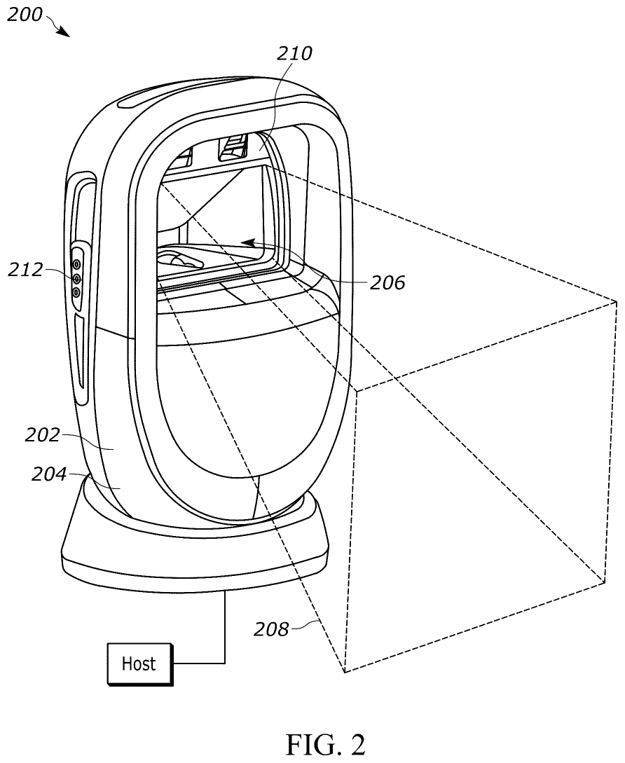

Another embodiment of an optical imaging reader in accordance with the teachings of this disclosure is illustrated in FIG. 2. The reader 200 may be referred to as an indicia reader, and the reader device may be handheld to move around a target to scan indicia or the reader 200 may be stationary, for example, free standing on a countertop. In the example shown, the reader 200 includes a housing 202 having a lower housing portion 204 and an optical imaging assembly 206. The optical imaging assembly 206 is at least partially positioned within the housing 202 and has a FOV 208. The reader 200 also includes an optically transmissive window 210 and a trigger 212.

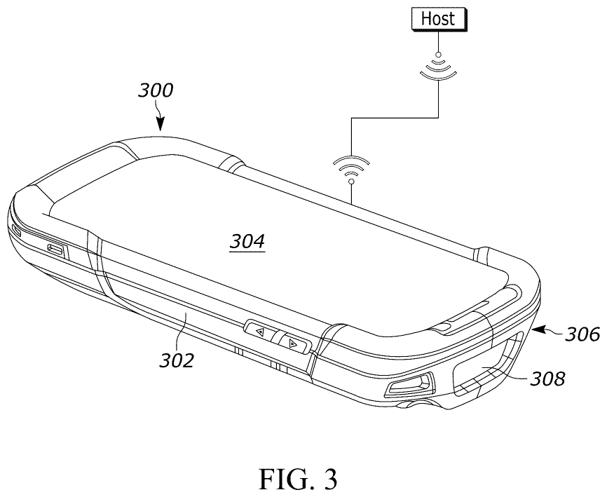

Another embodiment of an optical imaging reader in accordance with the teachings of this disclosure is illustrated in FIG. 3. In this embodiment, the imaging reader is embodied in a mobile computing device 300. Mobile device 300 includes a housing 302 supporting various other components of the device 300. Among the components supported by the housing 302 are a display 304 that, in the illustrated example, also includes an integrated touch screen. The housing 302 can also support a data capture module 306 like the imaging reader of the various embodiments described herein. This data capture module 306 is positioned behind the window 308 through which the module 306 can capture images and/or illumination to detect and decode indicia such as barcodes affixed to objects within the module's FOV.

Generally speaking, the form factors provided in FIGS. 1-3 are merely exemplary and the teaching of the present disclosure may be applied to imaging readers (otherwise referred to as imaging apparatuses) regardless of their physical configuration. For example, the teachings described herein may be implemented in devices like bi-optic indicia readers, slot scanners, imaging engines, machine vision cameras, and so on.

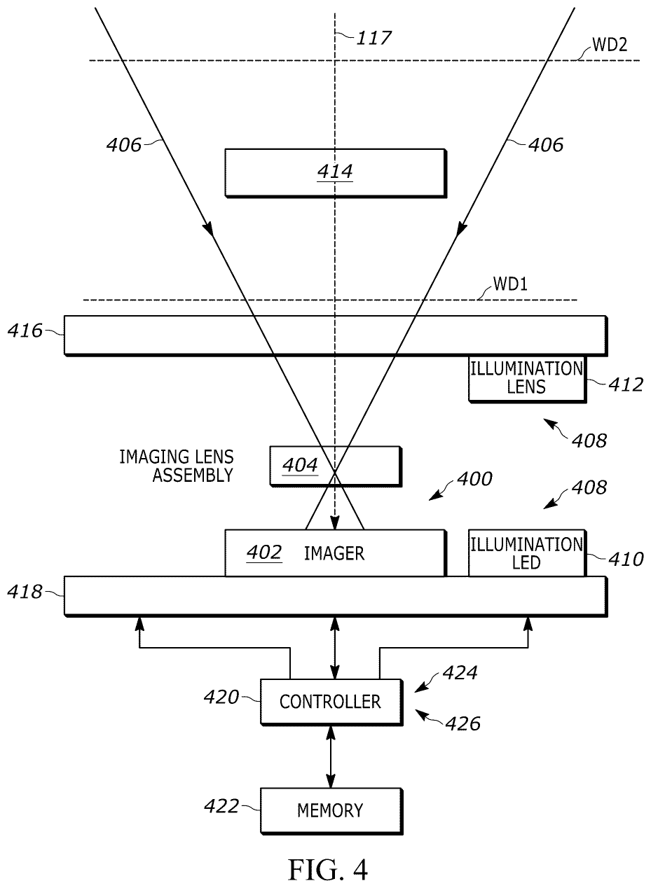

As shown in the schematic block diagram of various components of an example imaging apparatus of FIG. 4, these devices generally include an optical imaging assembly 400 that itself includes an image sensor 402 (also referred to as an imaging sensor or imager) together with an imaging lens assembly 404 that focuses and directs light over a predefined field of view (FOV) 406 onto the image sensor 402. To help capture images of sufficient quality, the imaging devices are further equipped with an illumination assembly 408 which commonly include an illumination source 410 and an illumination lens 412. The illumination source may be implemented as any source (like an LED source) operative to produce light that can illuminate an appropriate portion of the FOV 406 and provide sufficient light during image capture. In this manner, at least some light emitted by the illumination source away from the imaging apparatus will reflect off an object 414 being imaged and will be reflected by said object onto the imager 402, helping create a sufficiently illuminated image for various purposes, like barcode (also referred to as indicia) decoding. Additionally, the illumination source may be controlled to operate in accordance with various operating characteristics, particularly as outlined further in this disclosure.

These imaging components are typically housed in some type of a housing (like, for example, examples of FIGS. 1-3 or a housing of an imaging engine configured for further implementation in data capture devices) behind a window 416 and operate over some working range defined by a near working range WD1 and a far working range WD2. Range limits WD1 and WD2 may depend on the focusing capabilities of the imaging optics, the resolution of the image sensor, and/or the illumination characteristics.

The imaging assembly 400 and illumination assembly 410 may be positioned on same (or separate) printed circuit board 418 and each one may be controlled via a controller 420 (also referred to as a processor) which is operatively connected to at least some components of each assembly. Controller 420 may be embodied in one or more microprocessors that includes one or more modules for conducting the control functions associated with the imaging apparatus. It should be appreciated that while the controller is illustrated as a single element 420 in the block diagram of FIG. 4, its functional components may be separated over multiple physical processors in communication with each other such that, in combination, these components provide the necessary functionality of the imaging sensor 402 and the illumination source 410, along with the appropriate processing of image data, as disclosed further herein. The imaging apparatus further includes a memory 422 for storing instruction that, when executed by the controller 420 cause the imaging apparatus, or various components thereof, to perform in a particular manner. Furthermore, common additional components like a decode module 424 (also referred to as a decoder module or decoder) to analyze image data and to detect and decode indicum therein, an aimer assembly may also be implemented in the imaging apparatus and said apparatuses may be connected with their respective hosts such that data, like a payload of a decoded barcode, may be transmitted thereto.

Returning to the image sensor 402, it may be implemented as, for example, a two-dimensional CCD or a CMOS sensor that can be either a monochrome sensor or a color sensor having, for instance 1.2 megapixels arranged in a 1200×960 pixel configuration. It should be appreciated that sensors having other pixel-counts (both below and above) are within the scope of this disclosure. These two-dimensional sensors generally include mutually orthogonal rows and columns of photosensitive pixel elements arranged to form a substantially flat square or rectangular surface. Such imagers are operative to detect light captured by an imaging lens assembly along a respective optical path or axis that normally traverses through the window of the reader.

While illumination is generally seen as necessary (or at least desirable) for effective reading of barcodes printed on various media like paper, cardboard, plastic, etc., barcodes which appear on an illuminated screen of an electronic device do not require it. This is because the screen itself typically emits sufficient illumination for the imager to sufficiently capture the barcode in an image frame. Moreover, illumination can hinder the reading operations due to undesired specular reflections off the screen, which can obscure the barcode in the frame by appearing as a hotspot. As a result, in instances of capturing frames of barcodes on cell phones, tablets, or other digital screens the illumination should be sufficiently reduced so as not to create a reflected hotspot in the captured image, turned off, or time-shifted so as not to overlap with the exposure of the image sensor. Frames like this can be generally referred to as “cell phone frames” and when it is said that a reader is operating in cell-phone frame mode or when cell phone frames are mentioned in connection with a barcode reader it should be understood that the operation of the illumination assembly during the capture of those frames is modified as noted above.

The present disclosure proposes a novel approach to dynamically switching between a normal mode of operating the reader, which is configured to read printed or non-illuminated indicia, and a “cell-phone frame” mode of operation, which is optimized for reading barcodes from electronic displays. This dynamic adjustment is facilitated by leveraging a Neural Processing Unit (NPU) 426, which can be embodied within the barcode reader's controller or within a separate circuit, to execute a machine learning model trained to distinguish between various types of displays and printed media. The NPU may be provided as a hardware solution, it may be embodied in firmware, or it may be a purely software solution.

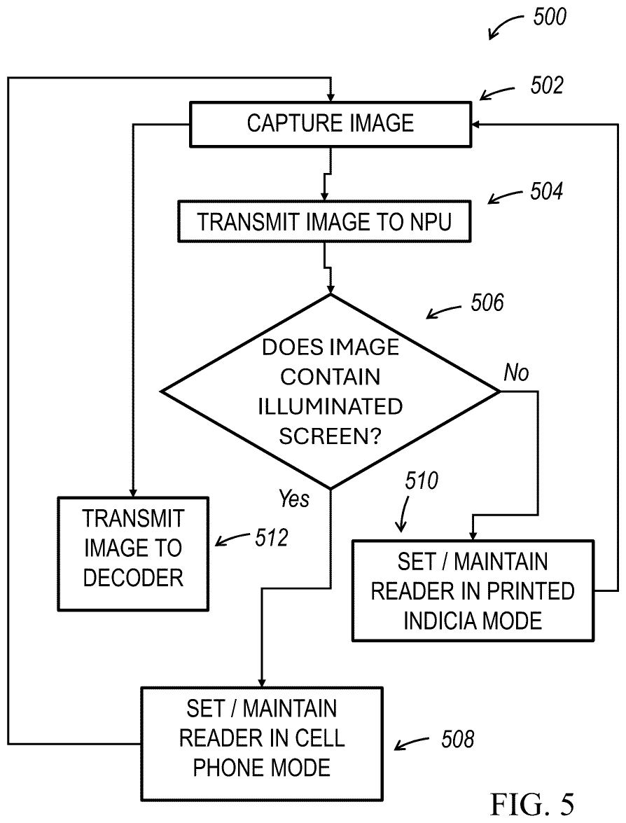

Referring to FIG. 5, an exemplary method 500 of operating the barcode reader begins with the step 502 of capturing image data during a decoding session, referred to as a scan session. A decoding session may be defined as a session where images are captured and fed to a decoder module for attempting to decode one or more indicia that are present in the image. The session may begin in response to an activation of a manual trigger, in response to a detection of an object coming into a field of view of the reader, or in response to some other wake-up signal. It may continue until a successful decode, until the trigger is disengaged, or until a timeout occurs with no successful decode.

In some embodiment, prior to transmitting the data to the decoder, the image data captured during the decoding session is send to 504 and processed by 506 the NPU, which runs a pre-trained machine learning model designed to identify the presence of a cell phone, a cell phone held in a hand, a computer display within the field of view (FOV) of the reader, or other similar illuminated display. This model utilizes image recognition techniques to analyze incoming frames and determine if a digital display is present. The recognition process involves analyzing pixel patterns, brightness levels, and screen-specific characteristics to accurately detect a display device. Note that the NPU may also be utilized on the back end of the decoder or simultaneously with the decoding operations.

When the NPU identifies a display, the system automatically adjusts 508 the image sensor and illumination settings. This adjustment involves either reducing or disabling the illumination to prevent specular reflections that can obscure the barcode, and optimizing the exposure settings to better capture the barcode presented on the screen. The system can also adjust focus and sensitivity settings to ensure that the screen-based barcodes are read accurately. If should be appreciated that if the frame in step 502 was captured with the reader operating in a cell phone mode, then this mode is simply maintained. Subsequent to that, assuming that the reading session has not terminated, the process returns to step 502 to capture a new image with the adjusted settings.

Conversely, if the NPU determines that no display is present in a given frame, due to the display not being presented in the first place or because it has exited the reader's FOV, the system operates in a normal mode of operation with the settings optimized for reading printed barcodes. This includes enabling the illumination system and/or adjusting the exposure settings to ensure that printed barcodes are captured with the sufficient quality. Again, if the frame in step 502 was captured with the reader operating in printed indicia mode, then this mode is simply maintained. Subsequent to that, assuming that the reading session has not terminated, the process returns to step 502 to capture a new image with the adjusted settings.

This dynamic adaptation occurs seamlessly in real-time, ensuring that the reader is always operating under optimal conditions for the type of barcode being scanned. The switching process is designed to be instantaneous to avoid any delay or disruption in the scanning process.

In certain embodiments, every image frame in a sequence of frames is ran through the NPU. In other embodiments the NPU may be utilized in a non-sequential manner whereby at least one frame between a series of frames is not ran through the NPU and instead during those frames the reader operates pursuant to the last configuration setting that has been set. Additionally, the reader man be configured to have a default mode, for example the normal mode being the default mode, where the first decode frame used for NPU purposes is captured with the illumination settings configured for print media. In other instances, the default mode may be reversed and the initial frames used for the NPU may be cell-phone frames.

In certain embodiments, the integration of the NPU allows for the machine learning model to run in parallel with the decoder module that handle the actual decoding of the barcode data. This means that there is little or no latency introduced to the decoding process, as the decoder is not burdened with the additional task of image classification. The parallel processing architecture separates the task of environmental recognition from decoding, allowing each process to be optimized for performance and speed. Consequently, the transmission of the image data to the decoder in step 512 may occur in parallel with the processing of the image data through the NPU.

This approach eliminates or reduces the need for end-user intervention to switch modes, as the system dynamically manages the operational settings based on real-time observations. This not only simplifies the user experience but also enhances the overall performance of the barcode reader in mixed environments where both printed and electronic barcodes are present. The automatic adjustment of settings ensures that the reader is always ready to handle any barcode type without manual configuration.

In terms of implementation, the machine learning model can be trained using a diverse dataset comprising various images of barcodes displayed on screens and printed on different media. This training process ensures that the model is robust and capable of accurately distinguishing between different surfaces, even under varying lighting conditions. The dataset might include scenarios with different ambient light levels, display brightness settings, and barcode orientations to ensure comprehensive training.

In some implementations, the system may be equipped with a feedback mechanism to fine-tune the machine learning model over time. This may include collecting data on scanning performance and user feedback to iteratively improve the model's accuracy and responsiveness. The feedback loop would allow the system to learn from real-world use cases, adapting to new types of displays or barcode presentations that were not part of the initial training set.

The above description refers to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICS or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. An indicia reader comprising:
a housing;
an imaging assembly housed within the housing, the imaging assembly including an image sensor and an imaging lens assembly configured to focus light onto the image sensor;
an illumination assembly configured to illuminate a field of view of the image sensor;
a Neural Processing Unit (NPU) configured to execute a machine learning model;
a controller operatively connected to the imaging assembly, the illumination assembly, and the NPU, the controller being configured to cause the indicia reader to:
capture, via the imaging assembly, image data during a decoding session;
process the image data using the NPU to determine a presence of a display device within the field of view;
responsive to the presence of the display device within the field of view, maintaining the indicia reader or adjusting the indicia reader to operate in a first mode optimized for reading indicia on an electronic display; and
responsive to a lack of the presence of the display device within the field of view, maintaining the indicia reader or adjusting the indicia reader to operate in a second mode optimized for reading indicia on non-electronic-display media.

2. The indicia reader of claim 1, wherein the display device is one of a cell phone, a cell phone held in a hand, or a computer display.

3. The indicia reader of claim 1, wherein the decoding session is defined as lasting between a trigger to activate the imaging assembly in response to an external triggering event and at least one of a timeout period, receipt of a signal indicative of a successful decode of an indicia, or a signal indicative of a termination of the external triggering event.

4. The indicia reader of claim 1, wherein the indicia reader is an imaging engine configured to be integrated into a data capture device.

5. The indicia reader of claim 1, wherein the machine learning model is trained using a dataset comprising images of indicia on both electronic displays and non-electronic-display media.

6. The indicia reader of claim 1, wherein the NPU processes image data in parallel with a decoder module that handles indicia decoding.

7. The indicia reader of claim 1, further comprising a feedback mechanism for updating the machine learning model based on images captured by the indicia reader.

8. The indicia reader of claim 1, wherein, in the first mode the illumination assembly is configured to provide less illumination during an exposure of the image sensor than in the second mode.

9. A method of operating an indicia reader, the method comprising:
capturing image data via an imaging assembly during a decoding session, the imaging assembly including an image sensor and an imaging lens assembly configured to focus light onto the image sensor;
processing the image data using a Neural Processing Unit (NPU) executing a machine learning model to determine a presence of a display device within a field of view;
responsive to the presence of the display device within the field of view, maintaining or adjusting the indicia reader to operate in a first mode optimized for reading indicia on an electronic display; and
responsive to a lack of the presence of the display device within the field of view, maintaining or adjusting the indicia reader to operate in a second mode optimized for reading indicia on non-electronic-display media.

10. The method of claim 9, wherein the display device is one of a cell phone, a cell phone held in a hand, or a computer display.

11. The method of claim 9, wherein the decoding session is defined as lasting between a trigger to activate the imaging assembly in response to an external triggering event and at least one of a timeout period, receipt of a signal indicative of a successful decode of an indicia, or a signal indicative of a termination of the external triggering event.

12. The method of claim 9, wherein the indicia reader is an imaging engine configured to be integrated into a data capture device.

13. The method of claim 9, wherein the machine learning model is trained using a dataset comprising images of indicia on both electronic displays and non-electronic-display media.

14. The method of claim 9, further comprising processing image data in parallel with a decoder module that handles indicia decoding.

15. The method of claim 9, further comprising updating the machine learning model based on images captured by the indicia reader.

16. The method of claim 9, wherein in the first mode, an illumination assembly is configured to provide less illumination during an exposure of the image sensor than in the second mode.

17. A non-transitory computer-readable medium storing instructions that, when executed by a processor, cause an indicia reader to perform operations comprising:
capturing image data via an imaging assembly during a decoding session, the imaging assembly including an image sensor and an imaging lens assembly configured to focus light onto the image sensor;
processing the image data using a Neural Processing Unit (NPU) executing a machine learning model to detect a presence of a display device within a field of view;
responsive to the presence of the display device within the field of view, maintaining or adjusting the indicia reader to operate in a first mode optimized for reading indicia on an electronic display; and
responsive to a lack of the presence of the display device within the field of view, maintaining or adjusting the indicia reader to operate in a second mode optimized for reading indicia on non-electronic-display media.

18. The computer-readable medium of claim 17, wherein the instructions further cause the indicia reader to identify the display device as one of a cell phone, a cell phone held in a hand, or a computer display.

19. The computer-readable medium of claim 17, wherein the decoding session is defined as lasting between a trigger to activate the imaging assembly in response to an external triggering event and at least one of a timeout period, receipt of a signal indicative of a successful decode of an indicia, or a signal indicative of a termination of the external triggering event.

20. The computer-readable medium of claim 17, wherein the instructions facilitate processing image data in parallel with a decoder module that handles indicia decoding.
